(19) United States
(12) Patent Application Publication
(10) Pub. No.: US 2013/0234649 A1
(43) Pub. Date: Sep. 12, 2013

(54) BATTERY MANAGEMENT SYSTEM AND METHOD THEREFOR

(71) Applicant: Aaron Richard Sevier, Santa Monica, CA (US)

(72) Inventors: Aaron Richard Sevier, Santa Monica, CA (US); Mack Ray McCoy, Irvine, CA (US)

(73) Assignee: Belkin International, Inc., Playa Vista, CA (US)

(21) Appl. No.: 13/276,245

(22) Filed: Oct. 18, 2011

Related U.S. Application Data
(60) Provisional application No. 61/394,342, filed on Oct. 18, 2010.

(51) Int. Cl. H02J 7/00

(52) U.S. Cl. CPC H02J 7/007
USPC 320/107; 320/137

(57) ABSTRACT

In some embodiments, a battery management system configured to control electrical charging of a battery of a user computing device when the user computing device is electrically coupled to an external charging unit. The external charging unit can be configured to provide electrical power to the user computing device. The battery management system can include: (a) a context analyzer module configured to run on a first controller and further configured to determine one or more optimal procedures to charge the battery of the user computing device; and (b) a determination module configured to run on the first controller and further configured to determine a first charging procedure to charge the battery based on the one or more optimal procedures and further configured to manage charging of the battery of the user computing device. Other embodiments are disclosed.

### CROSS-REFERENCE TO RELATED APPLICATIONS

This application claims the benefit of U.S. Provisional Application No. 61/394,342, filed Oct. 18, 2010. U.S. Provisional Application No. 61/394,342 is incorporated herein by reference.

### FIELD OF THE INVENTION

This invention relates generally to electrical devices, and relates more particularly to such electrical device that manages the charging of batteries of electrical devices and methods of charging batteries.

### DESCRIPTION OF THE BACKGROUND

Almost all of the increasing number of available user computing devices, including telephones, personal digital assistants (PDAs), digital cameras, audio-visual devices, and so forth, routinely depends upon batteries as a power source. For convenience and to ease battery replacement costs, rechargeable batteries have found wide utility in powering contemporary consumer and business products. For example, nickel cadmium batteries may be used to energize user computing devices. and then they may be repeatedly recharged and reused. Rechargeable batteries can be recharged by plugging an AC (alternating current) powered external charger unit into the user computing devices and into an AC power wall receptacle. The AC-powered charger unit typically converts 110 or 120 volt AC current from an outlet to low voltage DC (direct current) power used to recharge the batteries. For example, user computing devices can include a universal serial bus (USB) connector, which plugs into a USB connector to charge the user computing devices.

One problem with traditional external charging units is that they use the same charging method regardless of the condition of the battery or the time frame in which the user needs the battery charged. For example, the user may need the user computing devices urgently, and the user would prefer the battery of the device to be charged as quickly as possible. In another example, the battery may have been charged and uncharged many times recently, and a battery refreshing process is needed to maximize the charge held and the life of the battery. Traditional, external charging units do not provide users with these various charging options.

Accordingly, a need or potential for benefit exists for a device or system that allows a user intelligent options regarding the method of charging a battery of an electrical device.

### BRIEF DESCRIPTION OF THE DRAWINGS

To facilitate further description of the embodiments, the following drawings are provided in which:

FIG. 1 illustrates a block diagram of a system for managing charging of at least one battery, according to a first embodiment;

FIG. 2 illustrates front view of an exemplary user computing device of the system of FIG. 1 coupled to an exemplary external charging unit of the system of FIG. 1, according to the first embodiment;

FIG. 3 illustrates a block diagram of a system for managing charging of at least one battery, according to a second embodiment;

FIG. 4 illustrates a block diagram of a system for managing charging of at least one battery, according to a third embodiment;

FIG. 5 illustrates a block diagram of a system for managing charging of at least one battery, according to a fourth embodiment; and

FIG. 6 illustrates a flow chart for an embodiment of a method of charging of a battery of a user computing device.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled but not be mechanically or otherwise coupled; two or more mechanical elements may be mechanically coupled, but not be electrically or otherwise coupled; two or more electrical elements may be mechanically coupled, but not be electrically or otherwise coupled. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

### DETAILED DESCRIPTION OF EXAMPLES OF EMBODIMENTS

In some examples, a battery management system configured to control electrical charging of a battery of a user computing device when the user computing device is electrically coupled to an external charging unit. The external charging unit can be configured to provide electrical power to the user computing device. The battery management system can include: (a) a context analyzer module configured to run on a first controller and further configured to determine one or more optimal procedures to charge the battery of the user computing device; and (b) a determination module configured to run on the first controller and further configured to determine a first charging procedure to charge the battery based on the one or more optimal procedures and further configured to manage charging of the battery of the user computing device.

In additional embodiments, an external charging unit configured to control electrical charging of a battery of a user computing device when the user computing device is electrically coupled to the external charging unit. The external charging unit can include: (a) a controller; (b) a power source configured to couple to an external power source; (c) an electrical interface configured to couple to the user computing device and further configured to provide electrical power to the user computing device; (d) a context analyzer module configured to run on the controller and further configured to determine one or more optimal procedures to charge the battery of the user computing device; (e) a determination module configured to run on the controller and further configured to determine a first charging procedure to charge the battery based on the one or more optimal procedures and further configured to manage charging of the battery of the user computing device; and (f) an implementation module configured to run on the controller and further configured to change one or more characteristics of the electrical power being provided to the user computing device through the electrical interface.

Still other embodiments teach a method of charging of a battery of a user computing device. The user computing device can be configured to receive electrical power from an external charging unit. The method can include: (a) analyzing one or more characteristics related to the user computing device to determine one or more optimal charging procedures; (b) determining a first charging procedure based the one or more optimal charging procedures; and (c) charging the battery of the user computing device using the first charging procedure.

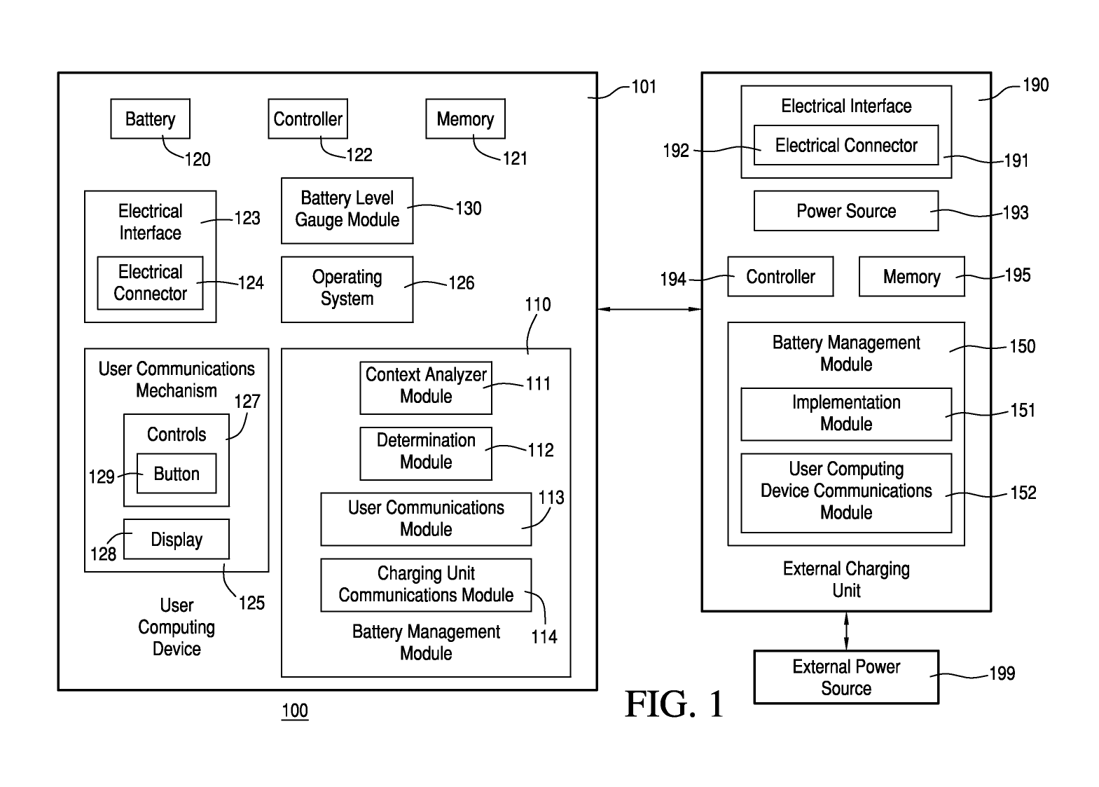

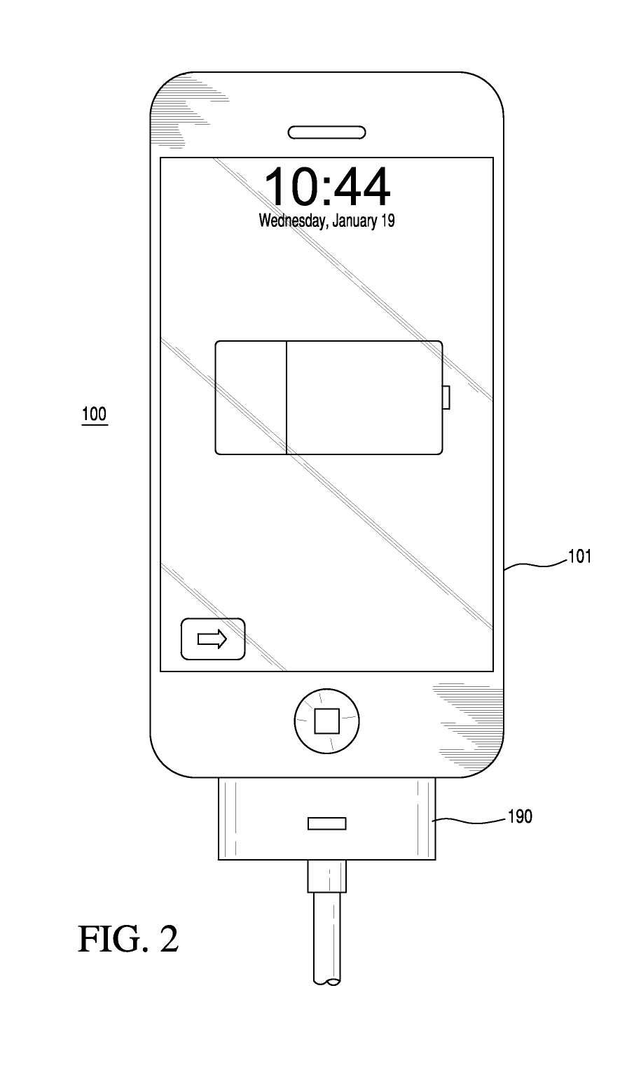

Turning to the drawings, FIG. 1 illustrates a block diagram of a system 100 for managing charging of at least one battery 120, according to a first embodiment. FIG. 2 illustrates front view of an exemplary user computing device 101 of system 100 coupled to an exemplary external charging unit 190 of system 100, according to the first embodiment. System 100 is merely exemplary and is not limited to the embodiments presented herein. System 100 can be employed in many different embodiments or examples not specifically depicted or described herein.

Not to be taken in a limiting sense, a simple example of the use of system 100 first involves a user coupling external charging unit 190 to user computing device 101. In some examples, external charging unit 190 can begin charging battery 120 of user computing device 101. Additionally, context analyzer module 111 can determine one or more optimal procedures for charging battery 120. In some embodiments, context analyzer module 111 can analyze one or more characteristics related to user computing device 101 to determine one or more optimal charging procedures.

The one or more characteristics used to determine the one or more optimal charging procedure can include: (a) an existing battery level of battery 120; (b) a current time; (c) a last time that battery 120 was charged; (d) one or more levels of current that external charging unit 190 can supply to user computing device 101; (e) a location of user computing device 101; (f) a temperature of battery 120; (g) a charging history (including date, charge start time, charge end time, charging duration, battery level at the beginning of charging, and battery level at the end of charging) of battery 120; and/or (h) an accuracy of a battery level gauge module 130 of user computing device 101.

In addition, the one or more optimal procedure can include a quick charge, a trickle charge, or a battery refresh. A quick charge is a charging of battery 120 using a high current (e.g., two amperes). A quick charge can charge battery 120 in the shortest amount of time, but can cause damage to battery 120 if battery 120 is charged using this procedure too often. A trickle charge is a charging of battery 120 using, for example, the manufacturer recommended charging current (e.g., ½ or 1 ampere) and voltage. In a trickle charge, battery 120 can be charge in a manner that does not damage the battery. A trickle charge can be slower than a fast charge, but faster than a battery refresh.

A battery refresh is a procedure where battery 120 is completely discharged, and after being completely discharged, battery 120 is completely charged using a trickle charge. In some embodiments, a battery refresh is a procedure that should be periodically implemented to maximize the charge capacity and the life of battery 120.

Other charging procedures can be variations of these three basic charging procedures. For example, another charging method can involve disabling or turning off one or more functionalities of user computing device 101 to decrease the charging time while charging battery 120. In one embodiment, a charging procedure can include turning off or disabling the wireless or cellular communication functionalities of user computing device 101. In the same or different embodiment, the charging procedure can include turning off or disabling one or more applications on user computing device 101. In still other charging procedures, user computing device 101 is turned off

In another charging procedure, the charging of user computing device 101 can be delayed one or more hours. For example, if context analyzer module 111 determines that a user is not going to use user computing device 101 for several hours (e.g., it is night time, and the user is probably going to bed based on the charge history of the particular user computing device) and if it will take an hour to charge battery 120, an optimal charging procedure could involve turning off user computing device 101 for several hours, and then charging battery 120 in the last hour or two before the user has historically begun using user computing device 101 again in the morning. This procedure or other related procedures can reduce or eliminate ghost power usage by user computing device 101 or external charging unit 190.

After determining the one or more optimal charging procedures, user communications module 113 can communicate at least one of the one or more optimal charging procedures to the user as recommended charging procedures. In some examples, the user can choose a first charging procedure from the one or more charging procedures. Determination module 112 and implementation module 151 can charge battery 120 using the first charging procedure.

Referring to FIG. 1, in some embodiments, a system 100 for managing charging of at least one battery 120 can include: (a) user computing device 101; and (b) external charging unit 190.

External charging unit 190 can be configured to provide electrical power to user computing device 101. In various embodiments, external charging unit 190 is automatically turned off until it is coupled to user computing device 101 to avoid ghost power usage. External charging unit 190 can include: (a) at least one electrical interface 191 with an electrical connector 192; (b) at least one power source 193; (c) a controller 194; (d) a memory 195; and (e) a battery management module 150 configured to run on controller 194.

In some embodiments, electrical interface 191 can include electrical connector 192 and electrical circuitry (if any) needed to use electrical connector 192. Electrical interface 191 can be electrically coupled to power source 193, controller 194, and memory 195. Electrical connector 192 can be configured to mechanically and electrically couple to electrical connector 124 of user computing device 101. For example, electrical connector 192 can be a thirty-pin male connector (e.g., a thirty pin dock connector on the iPhone® device, iPad® device, iTouch® device, and some iPod® devices of Apple Computer, Inc. in Cupertino, Calif.) and configured to mechanically and electrically couple to a thirty-pin female connector. In other examples, electrical connector 192 can be a male universal serial bus (USB), and electrical connector 124 can be a female USB connector.

In some example, power source 193 can be an internal battery of external charging unit 190 and/or an electrical power connector (e.g., a two or three prong electrical power plug) configured to couple to external power source 199 (e.g., an electrical wall outlet). In some examples, external charging unit 190 can be a computer or an electrical charging accessory.

In some examples, battery management module 150 can be configured to manage the charging of battery 120 in coordination with battery management module 110. Battery management module 150 can include: (a) implementation module 151; and (b) a user computing device communications module 152.

Implementation module 151 can be used to change one or more characteristics of the electrical power to the user computing device when implementing the first charging procedure. In some embodiments, implementation module 151 can be configured to modify the current being provided to user computing device 101. For example, when the first charging procedure is a fast charge procedure, implementation module 151 can increase the current of the electrical power being provided to user computing device 101 above the level of current provided to user computing device 101 when the first charging procedure is a trickle charge procedure. Additionally, in some examples, implementation module 151 controls the electrical charging procedure if user computing device 101 is turned off during the electrical charging procedure.

User computing device communications module 152 can be configured to manage communications with user computing device 101 (e.g., battery management module 110, user communications mechanism 125, operating system 126, and or battery level gauge module 130).

Memory 195 can be used to store information for external charging unit 190. For example, program instructions for implementation module 151 and/or user computing device communications module 152 can be stored in memory 195. In the same or different examples, information regarding the charging history of battery 120 can be stored in memory 195.

Controller 194 can be configured to control at least in part the operation of external charging unit 190 including, for example, management of the providing of electrical power to user computing device 101. When external charging unit 190 is running, program instructions stored in memory 195 are executed by controller 194. A portion of the program instructions stored in memory 195 can be suitable for the battery management functions of battery management module 150 as described herein. If controller 194 is a microcontroller, controller 194 can include memory 195.

User computing device 101 can be, for example, a mobile device or a personal computer. In some examples, user computing device 101 can include electrical devices of all types and designs (e.g., media players, PDAs, digital cameras, telephones, audio-visual media players, and devices incorporating media players, PDAs, digital cameras, telephones, and/or audio-visual devices). For example, user computing device 101 can be an electrical device manufactured by Sony Corp., Philips Corp., Audiovox Corp., Microsoft Corp. (e.g., the Zune® MP3 player), Research in Motion Limited (e.g., the Blackberry® device), Palm, Inc. (e.g., the Palm® device), or Apple Computer, Inc. (e.g., the iPod® MP3 player, the iTouch® device, iPad® device, and/or the iPhone® device). In other examples, user computing device 101 can be a portable computer (e.g., a laptop computer). In still other embodiments, user computing device 101 can be a digital camera.

In some examples, user computing device 101 can include: (a) at least one battery 120; (b) memory 121; (c) at least one controller 122; (d) at least one electrical interface 123 with at least one electrical connector 124; (d) a user communications mechanism 125; (e) a battery management module 110 configured to run on controller 122; (f) battery level gauge module 130 configured to run on controller 122; and (g) an operating system 126 configured to run on controller 122.

In some examples, battery level gauge module 130 is configured to run on controller 122. Battery level gauge module 130 is further configured to determine the charge level of battery 120. In some examples, battery level gauge module 130 can also determine the length of time that a user can continue to use battery 120 before battery is discharged. In many examples, battery level gauge module 130 can determine the remaining charge (and/or length of use) in battery 120 and communicate the charge level (and/or length of use) to operating system 126 and/or user communications mechanism 125. User communications mechanism 125 can communicate the charge level to the user of user computing device 101.

In some examples, battery management module 110 can be configured to manage charging of battery 120 in coordination with battery management module 150. Battery management module 110 can include: (a) context analyzer module 111; (b) determination module 112; (c) user communications module 113; and (d) charging unit communications module 114.

Context analyzer module 111 can be configured to determine one or more optimal procedures to charge battery 120 of user computing device 101. In some examples, the one or more optimal procedures can include a quick charge with a high current, a trickle charge, or a battery refresh.

Determination module 112 can be configured to determine a first procedure to charge the battery based on the one or more optimal procedures and further configured to manage charging the battery of the user computing device using the first charging procedure.

In some examples, user communications module 113 can receive information from a user regarding charging of battery 120. Determination module 112 can determine the first charging procedure based the one or more optimal charging procedures and the information from the user. For example, the information from the user can include a user preference for the procedure used to charge the user computing device.

In various embodiments, context analyzer module 111 and determination module 112 can use a feedback system to determine the one or more optimal charging procedures and the first charging procedure, respectively. For example, if a user has performed several fast charges recently, context analyzer module 111 can use this information to recommend performing a battery refresh.

User communications module 113 can be configured to receive via user communications mechanism 125 first information from a user of the user computing device 101 regarding charging of battery 120 of user computing device 101. In some embodiments, user communications module 113 is configured to receive the first information from the user in response to a query regarding a preferred charging method. For example, display 128 can be used to give the user a choice of one or more optimal charging methods.

Charging unit communications module 114 can be configured to manage communications with external charging unit 190 (e.g., battery management module 150).

Battery 120 can be configured to store electrical power and outputting power to run user computing device 101. Battery 120 can be charged by receiving electrical power from electrical interface 123. In some examples, controller 122 can be configured to control the characteristics of the electrical power (e.g., the voltage and/or current) provided to battery 120 from electrical interface 123. Controller 122 can also be configured to control the characteristics of the discharge of electrical power from battery 120 in some examples.

Memory 121 can be used to store information for user computing device 101. For example, program instructions for context analyzer module 111, determination module 112, user communications module 113, and/or operating system 126.

Controller 122 can be configured to control at least in part the operation of user computing device 101 including, for example, management of the charging and discharging of battery 120. When user computing device 101 is running, program instructions stored in memory 121 are executed by controller 122. A portion of the program instructions, stored in memory 121, can be suitable for the battery management functions of battery management module 110 as described herein. If controller 122 is a microcontroller, memory 121 can be incorporated into controller 122.

In some embodiments, electrical interface 123 can include an electrical connector 124 and electrical circuitry (if any) needed to use electrical connector 124. Electrical interface 123 can be electrically coupled to battery 120, memory 121, user communications mechanism 125, and/or controller 122. Electrical connector 124 can be configured to mechanically and electrically couple to electrical interface 191 of external charging unit 190. For example, electrical connector 124 can be a thirty-pin female connector (e.g., a thirty pin dock connector on the iPhone® device, iPad® device, iTouch® device, and some iPod® devices) configured to mechanically and electrically couple to a thirty-pin male connector (i.e., electrical connector 192). In other examples, electrical connector 124 can be a female universal serial bus (USB), and electrical connector 192 can be a male USB connector.

User communications mechanism 125 can include: (a) one or more controls 127; and (b) at least one display 128. In various embodiments, controls 127 can include button 129 and the electrical circuitry to implement controls 127. Controls 127 are configured to control at least in part user computing device 101.

Any type of button can be used for button 129, and the term “button” should be broadly understood to refer to any type of mechanism (with or without moving parts) whereby the user can input to user computing device 101 his or her data signals, e.g., a mechanical pushbutton, an electrostatic pushbutton, an electrostatic array, or any other input device of any type. In other examples instead of or in addition to button 129, controls 127 can include a keyboard, a point device (e.g., a mouse), or other user input devices.

Display 128 can be used to display information to the user of user computing device 101. In many examples, display 128 is an LCD (liquid crystal display). In other examples, display 128 can be a touch screen.

In various embodiments, operating system 126 can be configured to run on controller 122. Operating system 126 can be software programs that manage the hardware and software resources of a computer and/or a computer network. Operating system 126 can perform basic tasks such as, for example, controlling and allocating memory, prioritizing the processing of instructions, controlling input and output devices, facilitating networking, and managing files. Examples of common operating systems for a computer include Microsoft® Windows, Mac® operating system (OS), UNIX® OS, and Linux® OS. Common operating systems for a mobile device include the iPhone® operating system by Apple Inc. of Cupertino, Calif., the Blackberry® operating system by Research In Motion (RIM) of Waterloo, Ontario, Canada, the Palm® operating system by Palm, Inc. of Sunnyvale, Calif., the Android operating system developed by the Open Handset Alliance, the Windows Mobile operating system by Microsoft Corp. of Redmond, Wash., or a Symbian operating system by Nokia Corp. of Espoo, Finland.

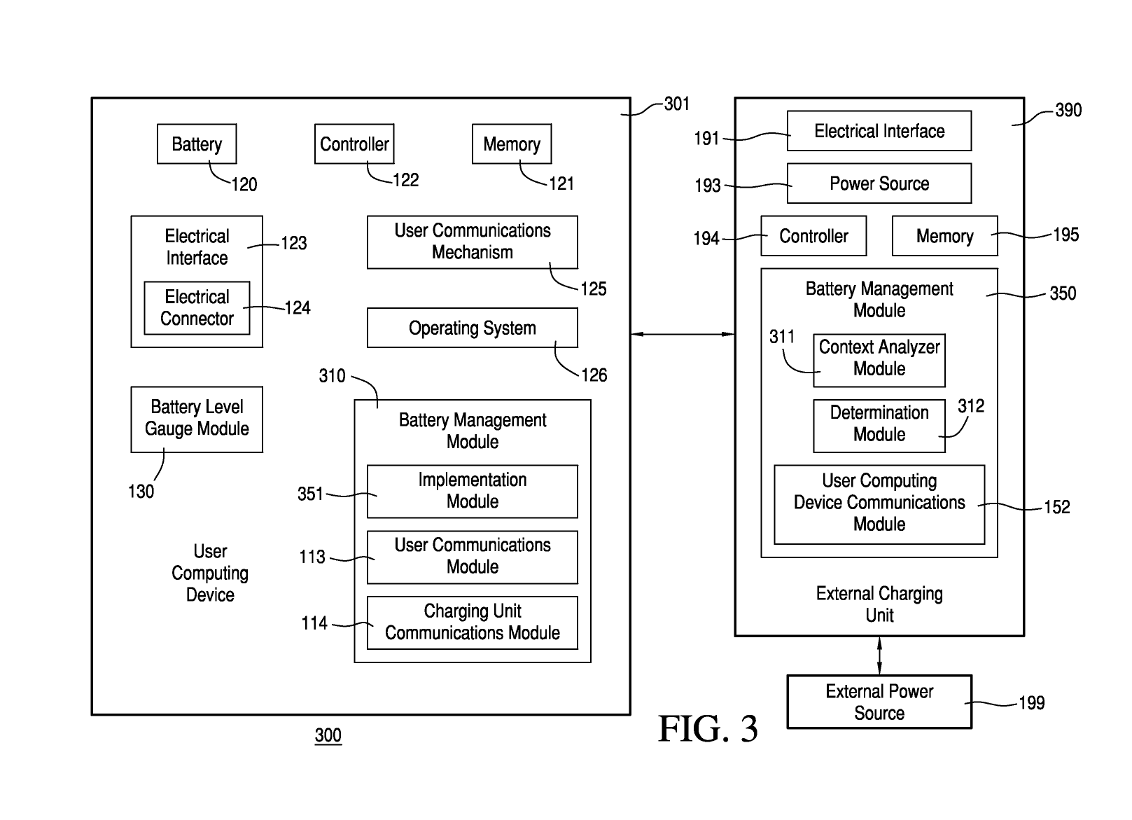

FIG. 3 illustrates a block diagram of a system 300 for managing charging of at least one battery 120, according to a second embodiment. System 300 is merely exemplary and is not limited to the embodiments presented herein. System 300 can be employed in many different embodiments or examples not specifically depicted or described herein.

For example in system 300 as shown in FIG. 3, context analyzer module 311, determination module 312 are located in battery management module 350 of external charging unit 390. An implementation module 351 configured to assist implementing the first charging procedure is located in battery management module 310 of user computing device 301.

That is, user computing device 301 can include: (a) at least one battery 120; (b) memory 121; (c) at least one controller 122; (d) at least one electrical interface 123 with at least one electrical connector 124; (e) user communications mechanism 125; (f) battery management module 310 configured to run on controller 122; (g) battery level gauge module 130 configured to run on controller 122; and (h) operating system 126 configured to run on controller 122.

In some examples, battery management module 310 can be configured to at manage charging of battery 120 in coordination with battery management module 350. Battery management module 310 can include: (a) implementation module 351; (b) user communications module 113; and (c) charging unit communications module 114. In some examples, implementation module 351 can be similar to implementation module 151, except that it is configured run on controller 122 and stored in memory 121, instead of running on controller 194 and being stored in memory 195.

External charging unit 390 can be configured to provide electrical power to user computing device 301. In various embodiments, external charging unit 390 is automatically turned off until it is coupled to user computing device 301 to avoid ghost power usage. External charging unit 390 can include: (a) at least one electrical interface 191; (b) at least one power source 193; (c) controller 194; (d) memory 195; and (e) battery management module 350 configured to run on controller 194.

Battery management module 350 can include: (a) context analyzer module 311; (b) determination module 312; and (c) user computing device communications module 152. In some examples, context analyzer module 311 and determination module 312 can be similar or the same as context analyzer module 111 and determination module 112, except that they can be configured run on controller 194 and be stored in memory 195, instead of running on controller 122 and being stored in memory 121.

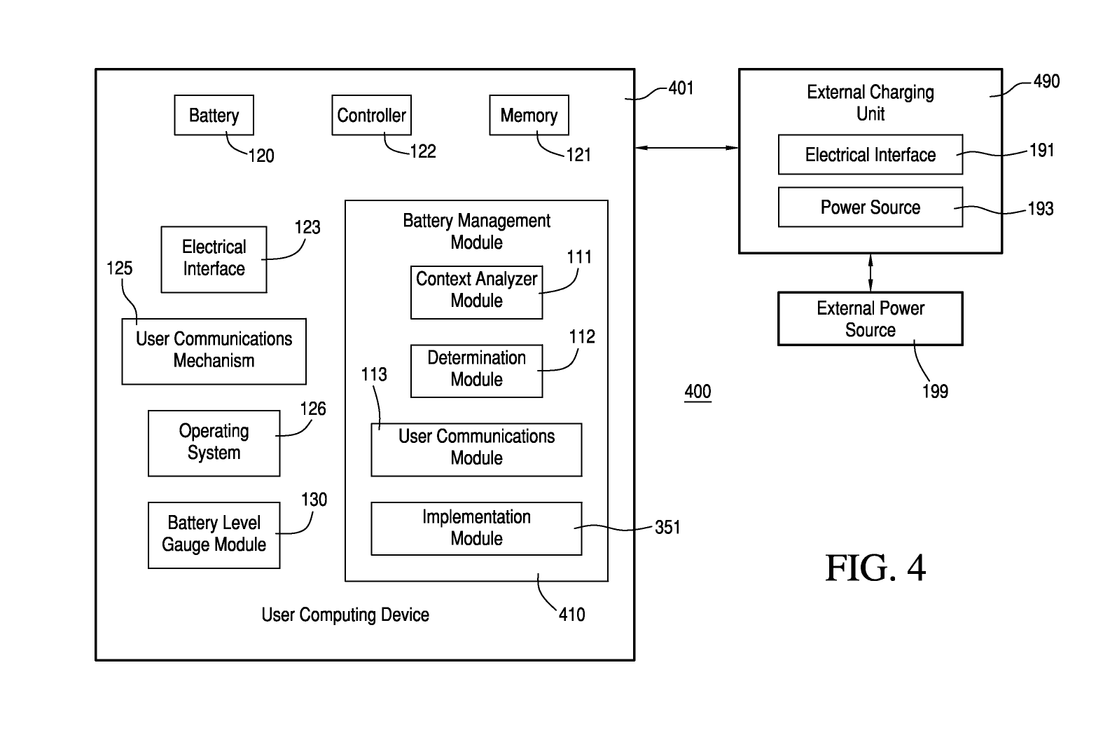

FIG. 4 illustrates a block diagram of a system 400 for managing charging of at least one battery 120, according to a third embodiment. System 400 is merely exemplary and is not limited to the embodiments presented herein. System 400 can be employed in many different embodiments or examples not specifically depicted or described herein.

In system 400 shown in FIG. 4, managing the charging of battery 120 is completely performed by battery management module 410 of user computing device 401. External charging unit 490 can be a dumb charging unit in some examples.

That is, user computing device 401 can include: (a) at least one battery 120; (b) memory 121; (c) at least one controller 122; (d) at least one electrical interface 123; (e) user communications mechanism 125; (f) battery management module 410 configured to run on controller 122; (g) battery level gauge module 130 configured to run on controller 122; and (h) operating system 126 configured to run on controller 122.

In some examples, battery management module 410 can be configured to manage charging of battery 120. Battery management module 410 can include: (a) implementation module 351; (b) user communications module 113; (c) context analyzer module 111; and (d) determination module 112.

External charging unit 490 can be configured to provide electrical power to user computing device 401. In various embodiments, external charging unit 490 can include: (a) at least one electrical interface 191; and (b) at least one power source 193.

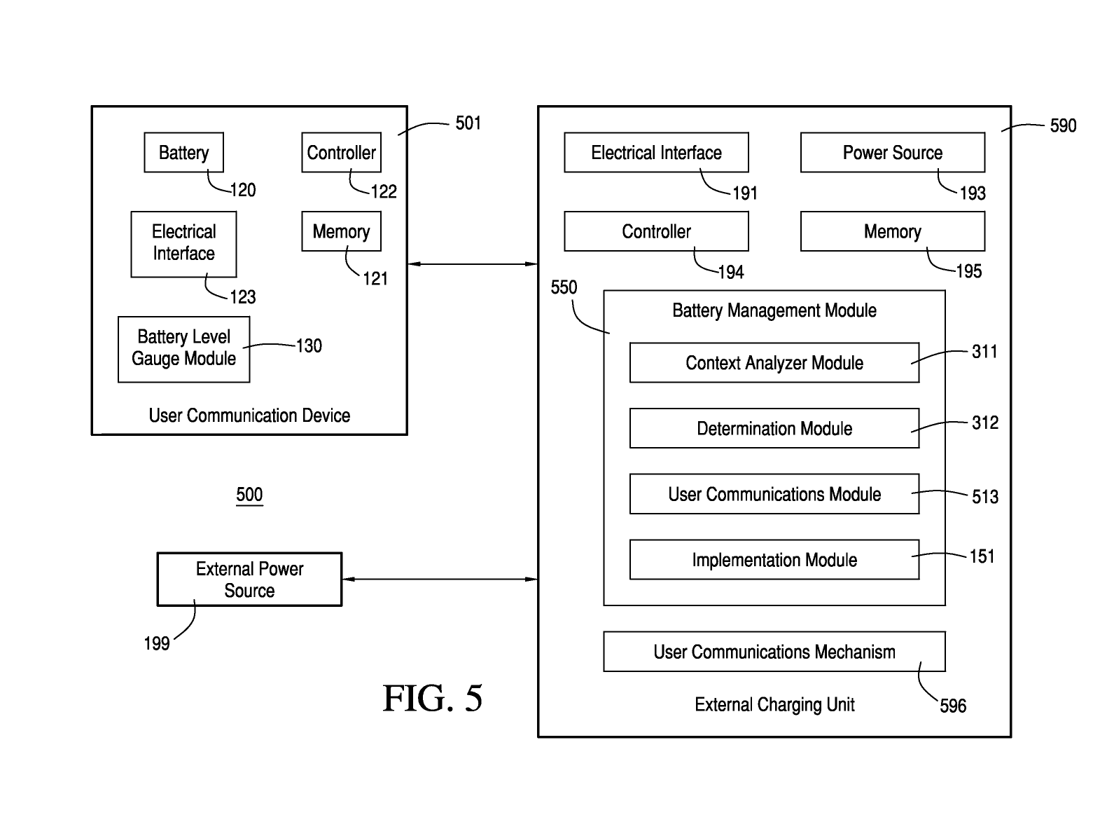

FIG. 5 illustrates a block diagram of a system 500 for managing charging of at least one battery 120, according to a fourth embodiment. System 500 is merely exemplary and is not limited to the embodiments presented herein. System 500 can be employed in many different embodiments or examples not specifically depicted or described herein.

In system 500 shown in FIG. 5, managing the charging of battery 120 is completely performed by battery management module 550 of external charging unit 590.

That is, user computing device 501 can include: (a) at least one battery 120; (b) memory 121; (c) at least one controller 122; (d) at least one electrical interface 123; and (e) battery level gauge module 130 configured to run on controller 122.

External charging unit 590 can be configured to provide electrical power to user computing device 501. In various embodiments, external charging unit 590 is automatically turned off until it is coupled to user computing device 501 to avoid ghost power usage. External charging unit 590 can include: (a) at least one electrical interface 191; (b) at least one power source 193; (c) controller 194; (d) memory 195; (e) a battery management module 550 configured to run on controller 194; and (f) a user communications mechanism 596 configured to communicate with the user of user communication device 501.

In some examples, battery management module 550 can be configured to manage charging of battery 120. Battery management module 550 can include: (a) implementation module 151; (b) a user communications module 513; (c) context analyzer module 311; and (d) determination module 312.

User communications mechanism 596 can be configured to receive information from a user of the user computing device regarding charging of the battery of the user computing device. For example, user communications mechanism 596 can include controls and a display.

User communications module 513 can be configured to receive via user communications mechanism 596 information from a user of the user computing device 501 regarding charging of the battery of the user computing device. In some embodiments, user communications module 513 is configured to receive the information from the user in response to a query regarding a preferred charging method.

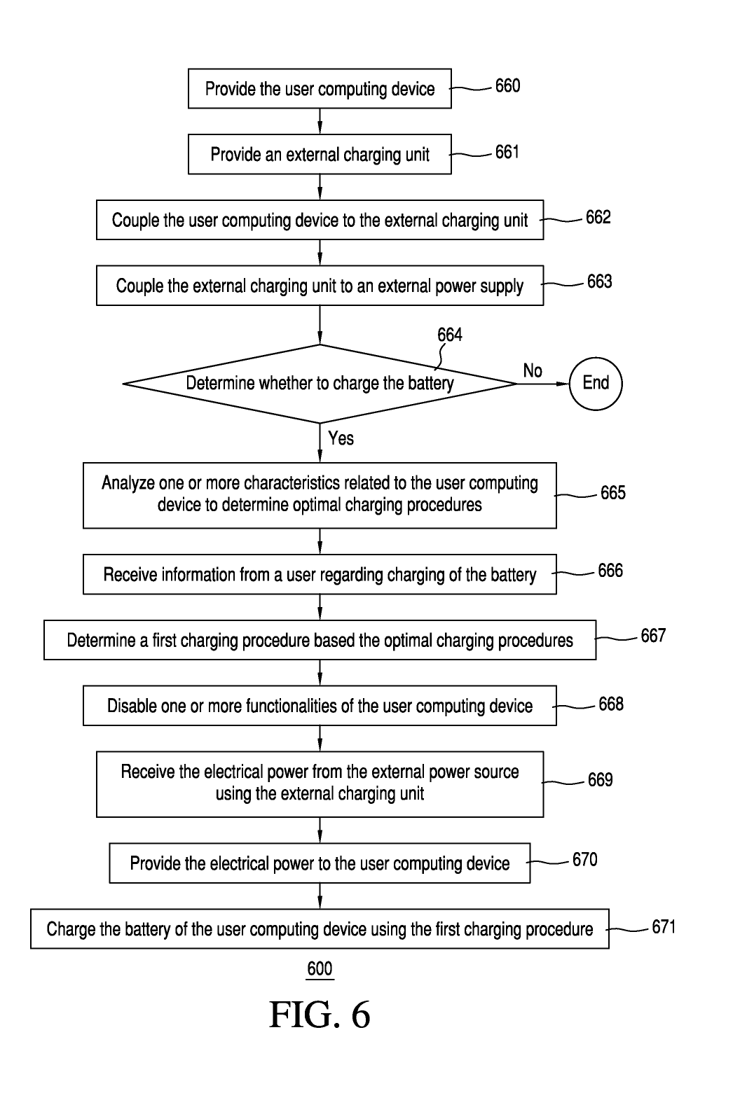

FIG. 6 illustrates a flow chart for an embodiment of a method 600 of charging of a battery of a user computing device. Method 600 is merely exemplary and is not limited to the embodiments presented herein. Method 600 can be employed in many different embodiments or examples not specifically depicted or described herein. In some embodiments, the activities, the procedures, and/or the processes of method 600 can be performed in the order presented. In other embodiments, the activities, the procedures, and/or the processes of method 600 can be performed in any other suitable order. In still other embodiments, one or more of the activities, the procedures, and/or the processes in method 600 can be combined or skipped.

Referring to FIG. 6, method 600 includes an activity 660 of providing a user computing device. As an example, the user computing device can be similar or identical to user computing device 101, 301, 401, or 501 of FIGS. 1, 3, 4, and 5, respectively.

Method 600 in FIG. 6 continues with an activity 661 of providing an external charging unit. As an example, the external charging unit can be similar or identical to external charging unit 190, 390, 490, or 590 of FIGS. 1, 3, 4, and 5, respectively.

Subsequently, method 600 of FIG. 6 includes an activity 662 of coupling the user computing device to an external charging unit. In some embodiments, an electrical interface of the user computing device can be coupled to an electrical interface of the external charging unit. For example, electrical interface 123 (FIG. 1) can be coupled to electrical interface 191 (FIG. 1).

Next, method 600 of FIG. 6 includes an activity 663 of coupling the external charging unit to an external power supply. In some embodiments, a power source (e.g., an electrical plug) of the external charging unit can be coupled to an external power supply. For example, power source 193 (FIG. 1) can be coupled to external power source 199 (FIG. 1). In some embodiments, the sequence of activities 662 and 663 is reversed. In various embodiments, this activity can be skipped if, for example, the power source of the external charging unit includes an internal battery, and the external charging unit is going to charge the battery of the user computing device using its internal battery.

Method 600 in FIG. 6 continues with an activity 664 of determining whether to charge the battery of the user computing device. In some embodiments, a user communications mechanism of the user computing device or the external charging unit can give the user the option of charge the battery of the user computing device. For example, the user communications mechanism can be similar or identical to user communications mechanisms 125 and/or 596 of FIGS. 1 and 5, respectively. In these embodiments, if the user chooses to charge the battery, the next activity is an activity 665. If the user chooses not to charge the battery, method 600 is complete.

In other embodiments, the external power source can automatically charge the battery of the user computing device if the user couples the external power source to the user computing device. In these embodiments, activity 664 can be skipped.

Subsequently, method 600 of FIG. 6 includes activity 665 of analyzing one or more characteristics related to the user computing device to determine one or more optimal charging procedures. In some embodiments, the one or more characteristics can include, at least one of: (a) an existing battery level of the battery; (b) a current time; (c) a last time that the battery was charged; (d) one or more levels of current of the electrical power that the external charging unit can supply to the user computing device; (e) a location of the user computing device; (f) a temperature of the battery of the user computing device; (g) a charging history of the battery of the user computing device; or (h) an accuracy of a battery gauge of the user computing device. In some examples, a context analyzer module can analyze one or more characteristics related to the user computing device to determine the optimal charging procedures. As an example, the context analyzer module can be similar or identical to context analyzer module 111 or 311 of FIGS. 1 and 3, respectively.

Method 600 in FIG. 6 continues with an activity 666 of receiving information from a user regarding charging of the battery of the user computing device. The information from the user can include a user preference for charging the user computing device. In some examples, information is received from a user using user communications mechanism 125 of FIG. 1 or user communication mechanism 596 of FIG. 5.

Next, method 600 of FIG. 6 includes an activity 667 of determining a first charging procedure based the optimal charging procedures. In some examples, the first charging procedure includes one of: (a) a quick charge; (b) a trickle charge; or (c) a battery refresh. In the same or different embodiment, determining the first charging procedure can include determining the first charging procedure based the optimal charging procedures and the information from the user. In various examples, the determination module can determine a first charging procedure based the optimal charging procedures. As an example, the determination module can be similar or identical to determination module 112 or 312 of FIGS. 1 and 3, respectively.

Subsequently, method 600 of FIG. 6 includes an activity 668 of disabling one or more functionalities of the user computing device while charging the battery of the user computing device. In some examples, disabling functionalities can include turning off the user computing device while charging the battery of the user computing device. In some examples, an implementation module can be configured to disable one or more functionalities of the user computing device. As an example, the implementation module can be similar or identical to implementation module 151 or 351 of FIGS. 1 and 3, respectively.

Next, method 600 of FIG. 6 includes an activity 669 of receiving the electrical power from an external power source using the external charging unit.

Method 600 in FIG. 6 continues with an activity 670 of providing the electrical power to the user computing device using the external charging unit.

Subsequently, method 600 of FIG. 6 includes an activity 671 of charging the battery of the user computing device using the first charging procedure. In some examples, the implementation module can be configured facilitate the charging the battery of the user computing device using the first charging procedure.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that activities 660-671 may be comprised of many different activities, procedures and be performed by many different modules, in many different orders that any element of FIG. 1 may be modified and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A battery management system configured to control electrical charging of a battery of an user computing device when the user computing device is electrically coupled to an external charging unit, the external charging unit is configured to provide electrical power to the user computing device, the battery management system comprising:
a context analyzer module configured to run on a first controller and further configured to determine one or more optimal procedures to charge the battery of the user computing device; and
a determination module configured to run on the first controller and further configured to determine a first charging procedure to charge the battery based on the one or more optimal procedures and further configured to manage charging of the battery of the user computing device.

2. The battery management system of claim 1, further comprising:
an implementation module configured to run on a second controller and further configured to implement the first charging procedure.

3. The battery management system of claim 2, wherein:
the implementation module is configured to change one or more characteristics of the electrical power being provided to the user computing device from the external charging unit.

4. The battery management system of claim 1, wherein:
the first charging procedure comprises one of: a quick charge; a trickle charge, or a battery refresh.

5. The battery management system of claim 1, further comprising:
a user communications mechanism configured to receive first information from a user of the user computing device regarding charging of the battery of the user computing device, wherein:
the determination module is further configured to determine the first charging procedure to charge the battery of the user computing device based on the one or more optimal procedures and the first information.

6. The battery management system of claim 5, wherein:
the user communications mechanism is configured to receive the first information from the user in response to a query regarding a preferred charging procedure.

7. The battery management system of claim 1, wherein the user computing device comprises the first controller.

8. The battery management system of claim 1, wherein the external charging unit comprises the first controller.

9. The battery management system of claim 1, further comprising:
an implementation module configured to disable one or more functionalities of the user computing device while charging the battery of the user computing device.

10. An external charging unit configured to control electrical charging of a battery of an user computing device when the user computing device is electrically coupled to the external charging unit, the external charging unit comprising:
a controller;
a power source configured to couple to an external power source;
an electrical interface configured to couple to the user computing device and further configured to provide electrical power to the user computing device;
a context analyzer module configured to run on the controller and further configured to determine one or more optimal procedures to charge the battery of the user computing device;
a determination module configured to run on the controller and further configured to determine a first charging procedure to charge the battery based on the one or more optimal procedures and further configured to manage charging of the battery of the user computing device; and
an implementation module configured to run on the controller and further configured to change one or more characteristics of the electrical power being provided to the user computing device through the electrical interface.

11. The external charging unit of claim 10, further comprising:
a user communications mechanism configured to receive first information from a user of the user computing device regarding charging of the battery of the user computing device, wherein:
the determination module is further configured to determine the first charging procedure to charge the battery based on the one or more optimal procedures and the first information.

12. A method of charging of a battery of a user computing device, the user computing device is configured to receive electrical power from an external charging unit, the method comprising:
analyzing one or more characteristics related to the user computing device to determine one or more optimal charging procedures;
determining a first charging procedure based the one or more optimal charging procedures; and
charging the battery of the user computing device using the first charging procedure.

13. The method of claim 12, wherein:
the one or more characteristics comprise at least one of:
an existing battery level of the battery;
a current time;
a last time that the battery was charged;
one or more levels of current of the electrical power that the external charging unit can supply to the user computing device;
a location of the user computing device;
a temperature of the battery of the user computing device;
a charging history of the battery of the user computing device; or
an accuracy of a battery gauge of the user computing device.

14. The method of claim 12, wherein:
the first charging procedure comprises one of:
a quick charge;
a trickle charge; or
a battery refresh.

15. The method of claim 12, further comprising:
receiving information from a user regarding charging of the battery of the user computing device,
wherein:
determining the first charging procedure comprises: determining the first charging procedure based the one or more optimal charging procedures and the information from the user.

16. The method of claim 15, wherein:
the information from the user comprises a user preference for charging the user computing device.

17. The method of claim 12, further comprising:
disabling one or more functionalities of the user computing device while charging the battery of the user computing device.

18. The method of claim 12, further comprising:
automatically turning off the user computing device while charging the battery of the user computing device.

19. The method of claim 12, further comprising:
receiving the electrical power using the external charging unit from an external power source.

20. The method of claim 12, further comprising:
providing the electrical power to the user computing device using the external charging unit.
